(19) United States
(12) Patent Application Publication
(10) Pub. No.: US 2007/0025222 A1
(43) Pub. Date: Feb. 1, 2007

(54) Channel synchronization for two-dimensional optical recording

(75) Inventors: Albert Hendrik Jan Immink, Eindhoven (NL); Willem Marie Julia Marcel Coene, Eindhoven (NL); Johannes Wilhelmus Maria Bergmans, Eindhoven (NL); Jamal Riani, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/559,353

(22) PCT Filed: Jun. 8, 2004
(86) PCT No.: PCT/IB04/01969

§ 371 Date: Jan. 12, 2006

(30) Foreign Application Priority Data
Jun. 17, 2003 (EP) 03300031.6

(51) Int. Cl. G11B 20/14; G11B 20/10

(52) U.S. Cl. 369/59.2

(57) ABSTRACT

The present invention relates to a method for synchronizing the signals coming from a set of data channels of a two dimensional optical read-out system. Said synchronization method comprises a step of cross-correlating the signals of a pair of adjacent channels for determining a relative phase delay between said adjacent channels. It also comprises a step of iterating the cross-correlation step for the different pair of adjacent channels of the set of data channels. It finally comprises a step of compensating for the relative phase delays thus obtained in order to align the signals from adjacent channels with each other. The present invention is based on, for example, the use of the optical cross talk existing between adjacent channels in a cross correlator that is able to determine the relative phase between two adjacent channels.

### FIELD OF THE INVENTION

The present invention relates to a method for synchronizing signals coming from a set of data channels of a two dimensional optical read-out system.

The present invention also relates to a device implementing such a synchronization method and to a two-dimensional optical recording and/or reproducing apparatus including such a device.

This invention is, for example, particularly relevant for data storage on optical carriers.

### BACKGROUND OF THE INVENTION

In a conventional two-dimensional optical recording system, bits are stacked on a storage medium on a regular two-dimensional lattice and no distinction can be made between the tangential and radial direction. The system is ideally isotropic.

In practice, the two-dimensional area of a two-dimensional record carrier is organized in a slightly different way: the two-dimensional area is filled with successive revolutions of a so-called “broad spiral”. In such a broad spiral, the tangential direction is defined to be oriented along the direction of progression of the spiral. Read out of data in such a system is done in a parallel way, all bit-rows of the broad spiral being read-out simultaneously.

Data that are organized in such a broad spiral consist of a relatively large number of rows, for example 9, 11 or 13 rows, as shown in FIG. 1 in the case of 9 rows. A given number of optical spots is generated by introducing a grating in the beam of a semiconductor laser diode. The optical spots are focused on the medium by an objective lens having a relatively large field in such a way that the individual diffraction limited spots do not overlap for at least the central Airy profiles (1,4) and the first Airy rings (2,5), as shown in FIG. 2. A practical design criterion for the diffraction grating is that the second Airy rings (3,6) overlap.

FIG. 3 shows a block diagram of conventional hardware able to do bit detection on 11 parallel channels. For that purpose, the signals ch1 to ch11 from a photo diode integrated circuit PDIC are amplified thanks to variable gain amplifiers VGA (31), low-pass filtered thanks to noise and anti-aliasing filters LPF (32) and digitized thanks to analog-to-digital converters ADC (33) using an asynchronous clock CLK with a frequency near to 1 sample/bit. The digitized samples are used for further processing like equalization, sample rate conversion, and bit-detection. The equalizer 2D-EQ (35), sample rate converter 2D-SRC (36), and bit-detector 2D-BD (37) are here controlled by a hardware interface CNTRL (38).

The samples out 1 to out 11 resulting from the different channels have a relative phase delay with respect to each other corresponding to the spot arrangement on the storage medium. This delay must be compensated for by compensation means COMP (34) before performing certain signal processing algorithms. For example, a two-dimensional equalization needs samples from different channels that have a predetermined phase relation with respect to each other. Each deviation from this phase relation will lead to different properties of the two-dimensional equalizer. Moreover, reversing the order of the sample rate conversion 2D-SRC and of the equalization 2D-EQ would add an additional loop-delay of the equalization 2D-EQ to the total timing recovery loop of the bit detector (data-aided or decision directed clock recovery) and of the sample rate conversion 2D-SRC.

But the relative phase delay may be different from an integer number of channel clock periods. Said delay is the sum of integer delay Δx expressed in channel clock periods and a fractional delay δx expressed in fractions of said channel clock. Compensating for the integer delay is relatively simple by using cascaded D flip-flops clocked by the channel clock as is indicated in the block diagram of FIG. 3. But compensating for a fractional delay is a more difficult issue. A possible solution is described in “Splitting the unit delay—tools for fractional delay filter design” by T. I. Laakso, V. Välimäki, M. Karjalainen, and U. K. Laine, in IEEE Signal Processing Magazine, vol. 13, n°1, pp. 30-60, 1996. It consists in using an interpolation filter having taps depending on the actual measured delay. For example, a simple 4-tap interpolation filter is sufficient in most cases, although the filter characteristic is not ideal. But some over-sampling may be necessary to be able to implement said interpolation filter in practice.

In any case, it is necessary to have the delay information available before the delay can be compensated for. A possible timing recovery scheme is based on data-aided timing recovery using a training pattern and switching to decision directed timing recovery on the real data when phase locking on the training pattern is completed. Such a solution is described in “Digital Baseband Transmission and Recording” by J. W. M. Bergmans, Kluwer Academic Publishers, 1996. According to this solution, the response of the channel is split into the actual target response and the residual inter symbol interference ISI response that arises due to mismatch of the controlled parameter, i.e. the relative phase delay in this case.

Unfortunately, it is known from experience that a few 100 bits are needed before robust phase information is obtained. This imposes a large loop-delay on the timing recovery loop causing stability problems or a severe bandwidth limitation.

### SUMMARY OF THE INVENTION

It is an object of the invention to provide a method for synchronizing data samples coming from a set of data channels of a two-dimensional optical read-out system, which is less complex than the one of the prior art.

To this end, the synchronization method in accordance with the invention comprises the steps of:

cross-correlating the signals of a pair of adjacent channels for determining a relative phase delay between said adjacent channels,

iterating the cross-correlation step for the different pair of adjacent channels of the set of data channels,

compensating for the relative phase delays thus obtained in order to align the signals from adjacent channels with each other.

The present invention also relates to a device for implementing such a synchronization method, said device comprising:

cross-correlators adapted to determine the relative phase delays between pairs of adjacent channels,

a delay compensator for compensating for the relative phase delays thus obtained in order to align the signals from adjacent channels with each other.

The present invention finally relates to a two-dimensional optical recording and/or reproducing apparatus comprising such a synchronization device, which is able to deliver synchronized signals to a two-dimensional equalizer in series with a sample rate converter and a bit detector.

According to a first embodiment of the invention, the cross-correlation is based on the use of a cross-talk between signals that are measured in successive channels that correspond to adjacent bit-rows.

According to another embodiment of the invention, the cross-correlation is based on the use of a similarity between signals that are measured in successive channels that correspond to adjacent bit-rows, said similarity being realized by a predetermined preamble structure that is uniform along one basic direction of a two-dimensional bit-lattice corresponding to a set of adjacent bit-rows, other than the tangential direction of said lattice, i.e. the broad spiral.

These embodiments simplify the two-dimensional sample rate converter structure and make the design of said converter and of the two-dimensional equalizer orthogonal.

Therefore, it is made possible to have a first delay compensation in front of the two-dimensional equalizer that relieves the two-dimensional sample rate converter from delay compensation and that obtains relative phase information directly from the signals.

An additional advantage of such a delay compensation is that it can be designed and tested independently of the rest of the system because it does not rely on proper working of the timing recovery and bit-detection.

Yet another advantage is that the two-dimensional delay compensator, which is implemented as a separate sample rate converter, only needs a single delay parameter from the bit-detector while this detector is able to extract delay information from each of the channels. It results in N times more clock recovery information, where N is the number of parallel channels that are detected simultaneously, and in a simpler hardware.

### BRIEF DESCRIPTION OF THE DRAWINGS

The present invention will now be described in more detail, by way of example, with reference to the accompanying drawings, wherein:

FIG. 1 shows a 9-row broad spiral with a 9-spot grating,

FIG. 2 shows the Airy profiles of two adjacent spots,

FIG. 3 shows a block diagram of a device for doing bit-detection on 11 parallel channels in accordance with the prior art,

FIG. 4a and 4b show the evolution of the correlation function and of its first derivative as a function of a relative phase delay between adjacent tracks, respectively,

FIG. 5 is a block diagram of a complete device in accordance with the invention for doing bit-detection on 11 parallel channels,

FIG. 6 shows a block diagram of a first embodiment of a delay compensator in accordance with the invention using optical cross-talk,

FIG. 7 shows a block diagram of another embodiment of the delay compensator using optical cross-talk,

FIG. 8 is a block diagram of an embodiment with feed-forward delay compensation still using optical cross-talk,

FIG. 9 is a block diagram of an embodiment corresponding to a single parameter delay compensator using optical cross-talk,

FIG. 10 is a block diagram of an embodiment of a delay compensator using optical cross-talk and comprising an oscillator for controlling the analog-to-digital clock in order to keep the relative phase delay an integer number,

Fig. 11 is a schematic outline of a format for a 9-row broad spiral including a preamble part and a data-part,

FIG. 12 is a block diagram of another embodiment of the present invention based on this preamble structure, and

FIG. 13 is a block diagram of still another embodiment of the present invention based on this preamble structure.

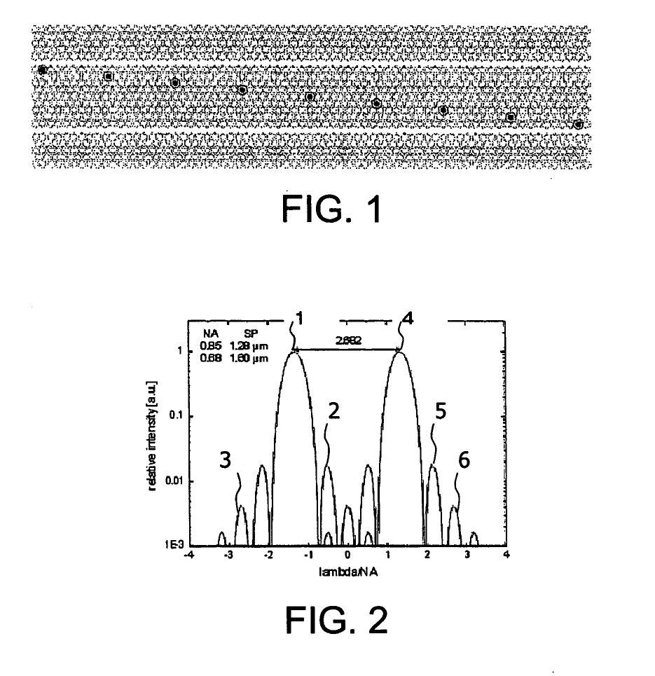

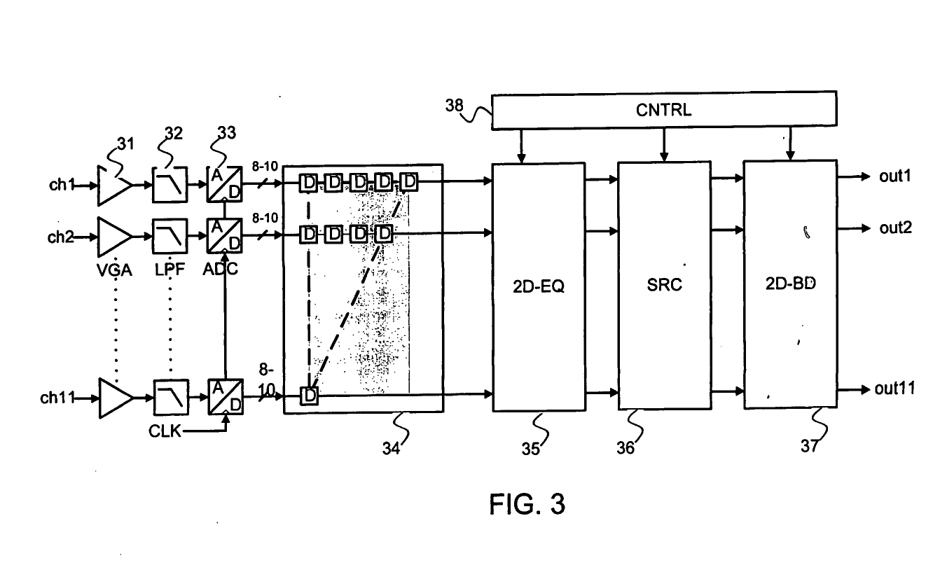

### DETAILED DESCRIPTION OF THE INVENTION

The present invention relates to a method and device for synchronizing signals coming from a set of data channels of a two dimensional optical read-out system.

Said invention is depicted in the following description in the case of data storage on optical carriers. However, it will be apparent to a person skilled in the art that said invention stays also applicable to equivalent systems such as, for example, two-dimensional magnetic recording systems when magnetic read/write heads need a slanted arrangement with respect to the tracks due to a minimum distance between the heads, for example due to processing limitations.

It has as an objective to make the synchronization device an independent operating signal processing block, independent from further timing recovery and sample-rate converter blocks.

Two-dimensional optical recording system are subjected to a large inter symbol interference ISI in both radial and tangential direction. This means, on the one hand, that the signal of a track I that is actually read out has a large component caused by the signal of a track 1+1. On the other hand, the signal of the track 1+1 contains a large component caused by the signal of the track 1.

As a consequence, if the signals from tracks 1 and 1+1 are correlated and if a search for the maximum peak in the correlation signal thus obtained is performed, a measure for the relative phase delay between the signal of track 1 and the signal of track 1+1 can be derived.

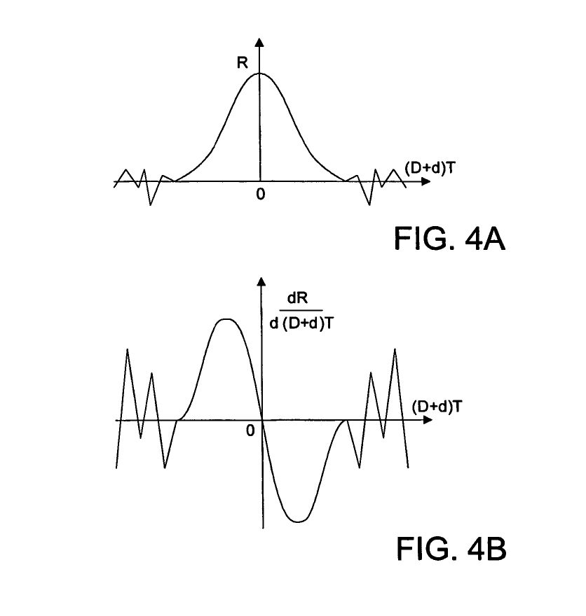

In effect, the correlation signal has a typical shape as a function of the relative phase delay like the one shown in FIG. 4a. However, it is to be noted that the correlation only gives valid information in a limited range around zero delay.

The correlation signal R for track 1 and track 1+1 can be written as follows:
R(k,(Δ+δ))=E(r¹_{kT}r¹⁺¹_{(k+Δ+δ)T}) (1)
where r¹_{kT}is a replay sample r of row 1 at instant kT.

To find the maximum, we search for the relative phase delay where the first derivative is zero, that is:

$$\frac{ⅆ}{ⅆ ( Δ + δ ) T} E ( {r}_{kT}^{1} {r}_{( k + Δ + δ ) T}^{l + 1} ) = 0 \\ equivalent to \\ E ( {r}_{kT}^{1} \frac{ⅆ}{ⅆ ( Δ + δ ) T} {r}_{( k + Δ + δ ) T}^{l + 1} ) = 0 \qquad ( 2 )$$

Because the derivative with respect to (Δ+δ)T is equivalent to the derivative with respect to t we can write:

$$E ( {r}_{kT}^{1} \frac{ⅆ}{ⅆ t} {r}_{( k + Δ + δ ) T}^{l + 1} ) = 0 \qquad ( 3 )$$

This last function has a ‘S-curve-like’ behavior as shown in FIG. 4b.

The information thus obtained can be used in a variable delay stage to compensate for the relative phase delay between track 1 and track 1+1. By repeating this procedure for each pair of adjacent tracks, all the tracks in a ‘broad-spiral’ arrangement can be aligned with respect to each other.

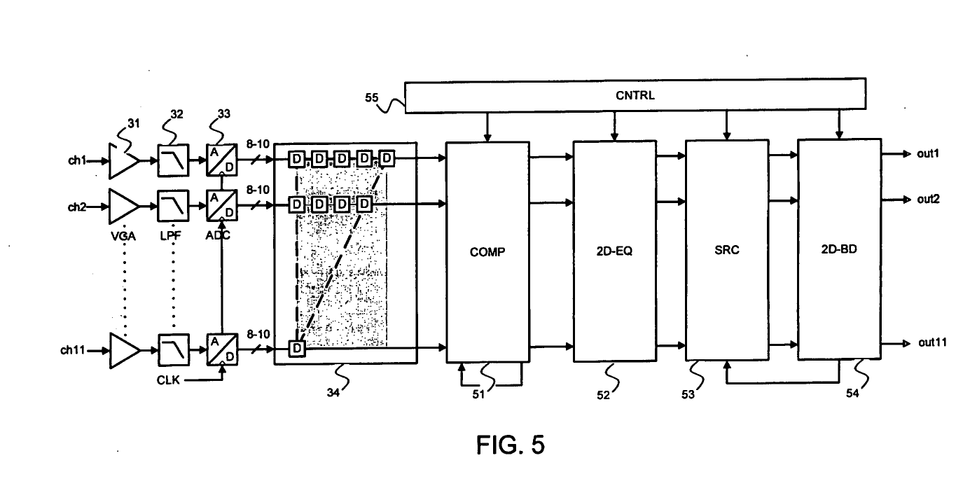

FIG. 5 is the block diagram of a complete architecture for doing bit-detection on 11 parallel channels in accordance with the invention.

Such architecture is able to receive signals ch1 to ch11 from a photo diode PDIC. Said architecture comprises:

variable gain amplifiers VGA (31), able to amplify the signals ch1 to ch11,

noise and anti-aliasing filters LPF (32) for low-pass filtering the amplified signals,

analog-to-digital converters ADC (33) for digitizing the filtered signals using an asynchronous clock CLK with a frequency near to 1 sample/bit,

means COMP (34) for compensating for an integer part of the relative phase delay of the digitized signals, said means comprising D flip-flops,

a delay compensator (51) for compensating for a fractional part of the relative phase delay, and means for further processing the compensated signals, said processing means comprising in series:

a two-dimensional equalizer 2D-EQ (52),

N times a one-dimensional sample rate converter SRC (53), and

a two-dimensional bit-detector 2D-BD (54).

The latter block (54) produces bit-decisions. Those bit-decisions are passed through a target response of the two-dimensional channel, hereby producing ideal waveform samples. Subtraction of these ideal waveform samples from the experimental values of the signal waveform yields error-samples, which can be correlated with the derivative of the target response in order to produce timing information that can drive the N sample-rate converters. This technique is known as decision-directed timing recovery and is depicted in more detail in “Digital Baseband Transmission and Recording”, by J. W. M. Bergmans, Kluwer Academic Publishers, 19996, Chapters 10-11.

The delay compensator and the further processing means are here controlled by a hardware interface CNTRL (55).

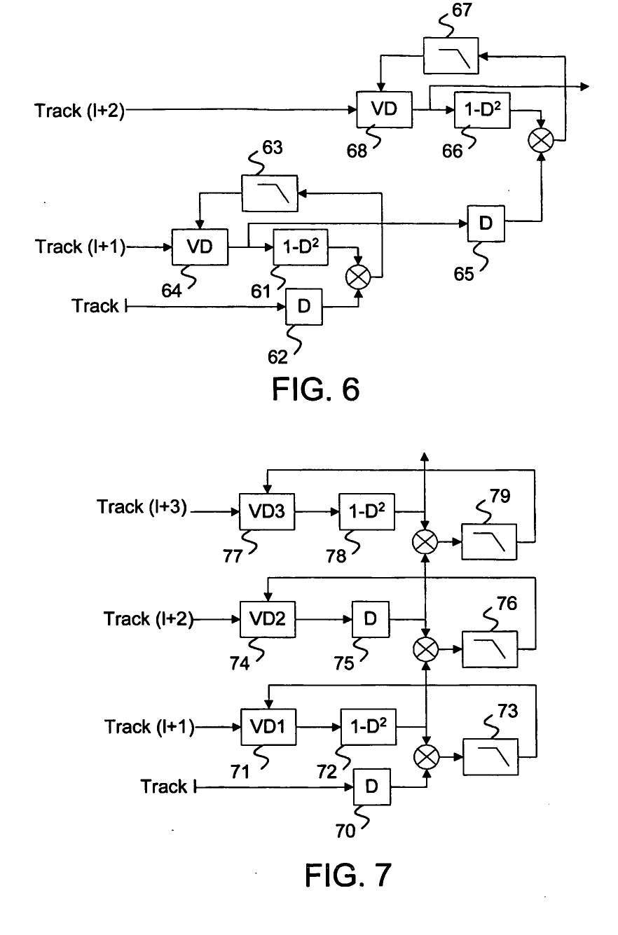

FIG. 6 shows a first embodiment of the implementation of a delay compensator in accordance with the invention.

According to this embodiment of the invention, the function described in equation (3) is implemented by taking the derivative of a first signal corresponding to track 1+1, said derivative being approximated by a first differentiator circuit (61) able to perform a (1−D²) operation, and multiplying said derivative with a second signal corresponding to track 1. D is the unit-delay operator, able to delay over one sampling interval. It is to be noted that the second signal is the signal from track 1 delayed by the predetermined delay D thanks to a first delay circuit (62), a flip-flop for example. This is also the reason why the differentiator is not implemented using a (1−D) operation because this would lead to an equivalent delay of D/2, which is difficult to realize, for example through interpolation. It is to be noted furthermore that, at low over-sampling, the (1−D²) differentiator leads to a decrease in terms of gain of the circuit, because of the poorer representation of the “real” full-fledged differentiator. It will be apparent to a person skilled-in-the-art that more complicated differentiators can be implemented, without departing from the scope of the present invention.

The relative phase error resulting from the multiplication is used as input for a first integrating loop filter (63), which forces the error to zero. The filter output is then used as input for a first variable delay circuit VD (64). Said variable delay circuit receives as another input the signal from track 1+1 and delivers an output which is used by the (1−D²) differentiator.

As shown in FIG. 6, the basic principle above described for adjacent tracks 1 and 1+1 is used iteratively to align all the tracks with respect to each other. For example, the output of the first variable delay circuit (64) is delayed by a delay D thanks to a second delay circuit (65) and then multiplied with the output of a second differentiator (66). The result of the multiplication is delivered to an input of a second integrating loop filter (67). The filter output is delivered to an input of a second variable delay circuit VD (68). Said variable delay circuit receives as another input the signal from track 1+2 and feeds the input of the second differentiator.

The outputs of the delay compensator are the signal waveform of track 1, the delayed version of the signal waveform of track 1+1, and the delayed version of the signal waveform of track 1+2, and of course when iteratively used for more tracks the delayed versions of the further used tracks in the system.

FIG. 7 shows another embodiment of an implementation of the delay compensator in accordance with the invention. Such an embodiment allows the bit-detection architecture to be further optimized.

According to this embodiment of the invention, the signal from track 1 is delayed by a delay D thanks to a first delay circuit (70). The signal from track 1+1 is delayed by a first variable delay VD1 thanks to a first variable delay circuit (71) and a first derivative of the variable delayed signal is taken thanks to a first (1−D²) differentiator (72). The outputs of the first delay circuit (70) and of the first (1−D²) differentiator (72) are multiplied and the result of the multiplication is delivered to an input of a first integrating loop filter (73), which is able to control the variable delay VD1 of the first variable delay circuit (71).

The signal from track 1+2 is delayed by a second variable delay VD2 thanks to a second variable delay circuit (74) and then delayed by a delay D thanks to a second delay circuit (75). The outputs of the first (1−D²) differentiator (72) and of the second delay circuit (75) are multiplied and the result of the multiplication is delivered to an input of a second integrating loop filter (76), which is able to control the variable delay VD2 of the second variable delay circuit (74).

The signal from track (1+3) is delayed by a third variable delay VD3 thanks to a third variable delay circuit (77) and a first derivative of the variable delayed signal is taken thanks to a second (1−D²) differentiator (78). The outputs of the second delay circuit (75) and of the second (1−D²) differentiator (78) are multiplied and the result of the multiplication is delivered to an input of a third integrating loop filter (79), which is able to control the variable delay VD3 of the third variable delay circuit (77).

The principle above described for adjacent tracks 1 to (1+3) is used iteratively to align all the tracks with respect to each other.

It is to be noted that the signal for a next stage is tapped after the variable delay, and the variable delay automatically becomes longer with increasing track number due to the integrating loop filter. To make sure that each of the control loops works in the proper range of the S-curve it is necessary to compensate for the nominal delay before the signal enters the variable delay loop. So each variable delay that is shown in the block diagram consists of a large fixed part and a smaller variable part. Even then the stacking may cause some problems because the error is integrated and at start-up the total error can be outside the proper range of the S-curve. Furthermore, the output of one control loop is the input of the next loop. This might lead to a long convergence time at start-up.

The outputs of the delay compensator are the signal waveforms of tracks 1, 1+1, 1+2 and 1+3, all aligned by their respective variable delay circuits, and in case the delay compensator block is used iteratively also the variable delayed signal waveforms for further tracks.

If we want to circumvent this problem of feeding the delayed version of the signal to the next stage we can simply apply the loop to each pair of adjacent channels and use the original non-delayed signals. In that case it is necessary to have additional delays after the first loop that compensate for the overall delay.

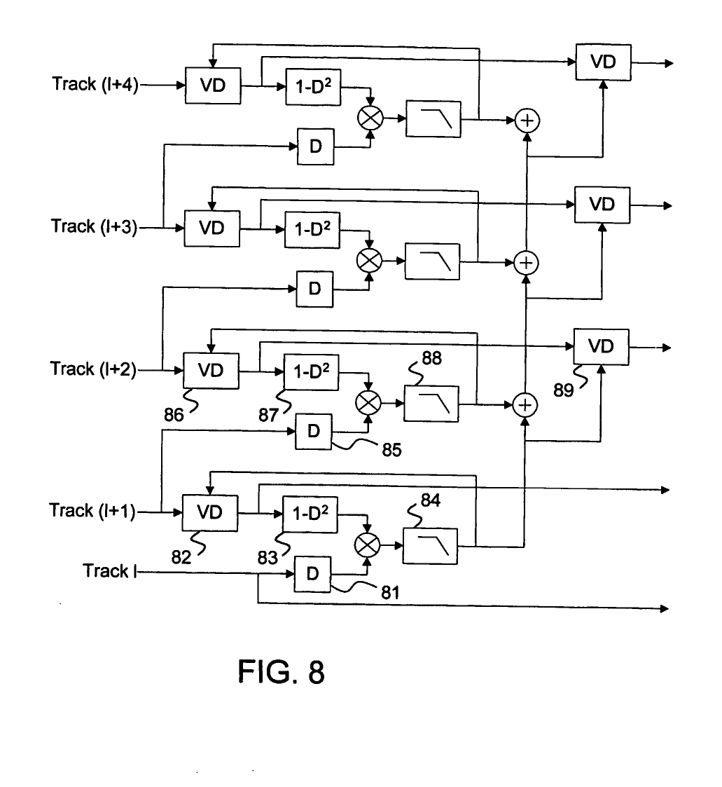

FIG. 8 shows a block diagram of such an embodiment with feed-forward delay compensation.

According to this embodiment of the invention, the signal from track 1 is delayed by a delay D thanks to a first delay circuit (81). The signal from track 1+1 is delayed by a variable delay VD thanks to a first variable delay circuit (82) and a first derivative of the variable delayed signal is taken thanks to a first (1−D²) differentiator (83). The outputs of the first delay circuit (81) and of the first (1−D²) differentiator (83) are multiplied and the result of the multiplication is delivered to an input of a first integrating loop filter (84), which is able to control the variable delay VD of the first variable delay circuit (82). The signals from track 1 and the output of the first variable delay circuit (82) form outputs of the delay compensator.

The signal from track 1+1 is delayed by a delay D thanks to a second delay circuit (85). The signal from track 1+2 is delayed by a variable delay VD thanks to a second variable delay circuit (86) and a first derivative of the variable delayed signal is taken thanks to a second (1−D²) differentiator (87). The outputs of the second delay circuit (85) and of the second (1−D²) differentiator (87) are multiplied and the result of the multiplication is delivered to an input of a second integrating loop filter (88), which is able to control the variable delay VD of the second variable delay circuit (86). The output of the first integrating loop filter (84) is added to the output of the second integrating loop filter (88). A third variable delay circuit (89) is controlled by the output of the first integrating loop filter (84) and the output of the second variable delay circuit (86). The output of the third variable delay circuit (89) forms another output of the delay compensator.

The principle above described for adjacent tracks 1 to 1+2 is used iteratively to align all the tracks with respect to each other.

The use of a large number of multipliers is not always desirable. Therefore, we could also take the sign of the signal after the differentiator. Because this signal has a zero direct component DC, as it is a differentiated version of the original signal, we can use a constant slicer level at zero. The multiplication now simplifies to an inversion of the sign bit in case the output of the slicer is negative. So, in FIG. 6 to 8 we can replace every (1−D²) differentiator with a (1−D²) differentiator followed by a slicer with zero reference level. The slicer produces the sign-bit at its output, hereby making all multipliers in the cross-correlators obsolete. As a consequence, the output of the (1−D²) differentiator circuit is sliced by simply taking the sign bit. The value of the sign, i.e. the sign bit, is combined with the sign bit of the signal at the output of the delay circuit D. This is done thanks to a combination circuit, which replaces the multiplier in the cross-correlator. The small disadvantage of this significant hardware simplification is the fact that the loop gain becomes dependent on the input data. This can have a small effect on the speed of capturing lock at start-up. But because the direction of adaptation stays the same the system will eventually converge to the same stable situation.

Another embodiment of the invention consists in using N registers to store the integrator values for the N variable delays. Then a single cross-correlator function is implemented and used for each pair of adjacent channels sequentially. The update value is added to the register value and stored again in the same register in order to implement the integration function. Such a simplification can only be applied if the variation in delay is sufficiently slow.

The embodiments described above show the most generic form of the delay compensation where we assume that each delay is independent and time varying.

But in some practical cases, it may be safely assumed that the inter-track delay is the same for each pair of tracks because it is fixed by the spot configuration, i.e. the grating. Thus, only one parameter needs to be controlled.

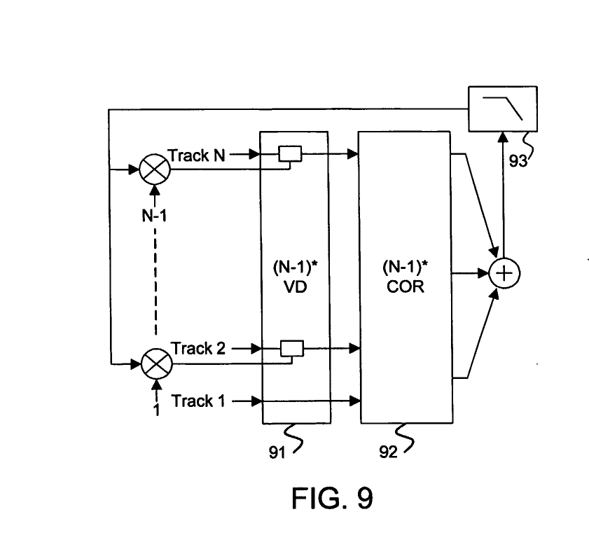

To this end, the signals from track 2 to N are delayed by a variable delay VD thanks to a set of N−1 variable delay circuits (91) as shown in FIG. 9. The signal from track 1 and the delayed signals form the inputs of a set of N−1 cross-correlators (92). The cross-correlator outputs are added and the result of the addition is taken as the input of an overall integrating loop filter (93). The loop filter output is then the input for each of the N−1 variable delay stages. FIG. 9 also shows that when the inter-track-delay is equal to (Δ+δ)T then the total delay for track 1 is (1−1)* (Δ+δ)T. Such architecture solves the convergence problem that was present in FIG. 6 and 7.

In order to minimize the hardware complexity, it is also possible to reduce the number of cross-correlators because ideally they all show the same result. For example one cross-correlator is used for the top 2 rows and one is used for the bottom 2 rows.

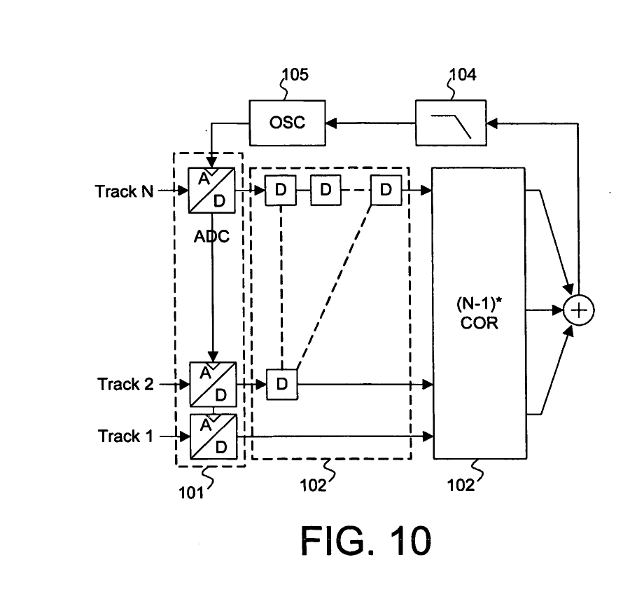

FIG. 10 is a block diagram of an embodiment comprising an oscillator for controlling the analog-to-digital clock in order to keep the relative phase delay an integer number.

In effect, the compensation of a fractional delay by an interpolation filter is not very easy. It needs some over-sampling to make the filter feasible to implement. Therefore, it would be nice if the inter-track-delay always equals an integer number of channel clock periods.

To this end, the analog-to-digital clock is tuned in such a way that the delay always becomes an integer delay, that is:
(Δ+δ)T=ΔT¹ equivalent to

$${f}_{c}^{1} = \frac{1}{1 + ( \frac{δ}{Δ} )} {f}_{c}$$

where f_{c} is the clock frequency.

An example of implementation consists in separating the fractional delay from the total delay by subtracting the integer delay.

As shown in FIG. 10, the signals from track 1 to N are digitized thanks to analog-to-digital converters ADC (101). Then, means for compensating (102) the digitized signals for an integer delay are used, said means comprising K D flip-flops for track 2 and K.(N−1) D flip-flops for track N, where K is the nominal integer part of the delay between adjacent tracks. The fractional delay is determined by correlating the signals from adjacent channels using a set of N−1 cross-correlators (103). The outputs of the set of cross-correlators are added, and the result of the addition forms an input of an integrating loop filter (104). The output of the loop filter drives a controlled oscillator (105), which generates the clock for the analog-to-digital converters ADC.

It is to be noted that this configuration only works in the particular case of equal delays between all the adjacent channels. The sample rate converter after the delay compensator and equalizer must be able to deal with this varying analog-to-digital clock and must be able to convert it to a fixed clock at the output of the sample rate converter.

Another embodiment of the invention consists in using of a predetermined structure of a preamble pattern that is uniform along one of the basic directions of the two-dimensional bit-lattice, other than the tangential direction.

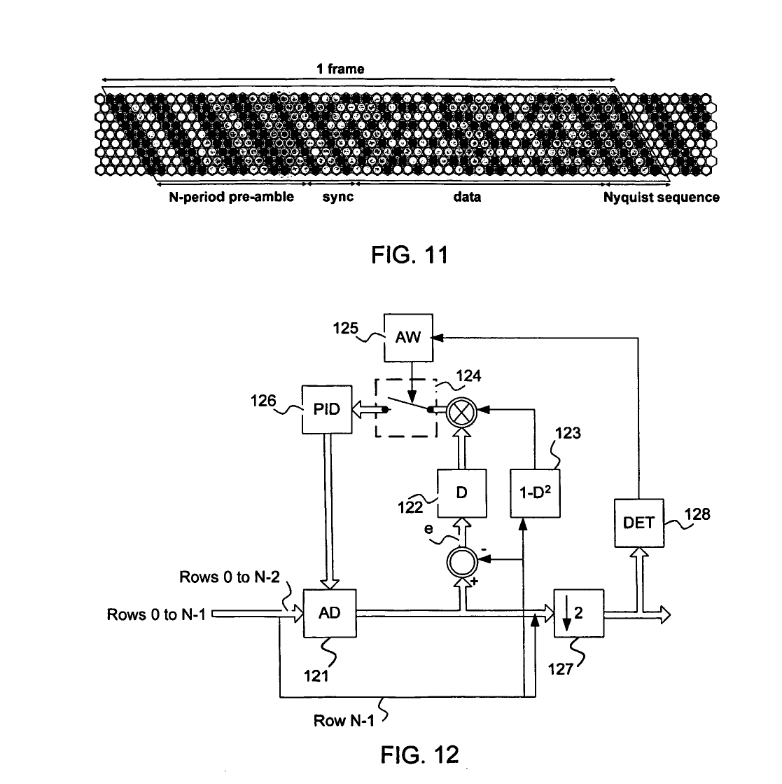

FIG. 11 is a schematic outline of a format for a 9-row broad-spiral including a preamble part and a data-part. The preamble part is arranged such that the signal waveforms in successive channels corresponding to adjacent bit-rows show similarity that can be used in the cross-correlator.

The uniformity of the preamble pattern yields similar signal waveforms for successive read-out spots located at successive bit-rows, but having fixed delays. Previous embodiments are based on the cross-talk between successive bit-rows for the cross-correlator. This additional embodiment is based on the similarity of the signal waveforms in successive bit-rows for the cross-correlator. In the previous embodiments of the invention, the cross-correlator is active continuously without any interruption. In this additional embodiment of the invention, the cross-correlator is only active in the preamble parts of the two-dimensional bit-lattice, and not in the data part.

FIG. 12 is a block diagram of this additional embodiment of the present invention. It is based on the uniformity of the preamble along one of the basic directions of the two-dimensional bit-lattice, other than the tangential direction. The inputs of the delay compensator consist of N signals coming from N rows 0 to N−1 of the broad spiral. One row, the row N−1 in our example, is taken as a reference row and is passed without being delayed in the system. The other rows 0 to N−2 are input to an adaptive delay circuit AD (121). The outputs of the adaptive delay circuit are subtracted from the non-delayed reference row, thus forming an error e. The error e is delayed by one clock period by a delay circuit D (122). The derivative of the signal of the reference row is determined using a differentiator (123), a (1−D²) differentiator circuit in our example. The output of said differentiator is multiplied by the output of the delay circuit D resulting in the correlation of the signals. The output of this multiplier forms an input of a loop switch (124), which is controlled by a control block AW (125) that determines the acquisition window. The output of the loop switch is used by a loop filter PID (126) to form the delay information. The delay information at the output of the filter PID determines the delay of each row in the variable delay block. After the delay block the signals including the non-delayed reference signal are down-sampled by a factor of 2 by a down-sampler (127). Finally, the acquisition window is determined based on the output of a preamble detector (128). The preamble detector works on the output signals of the down-sampler. In this way the delay values are only updated during the preamble where the data are uniform along one of the basic directions of the two-dimensional bit-lattice, other than the tangential direction.

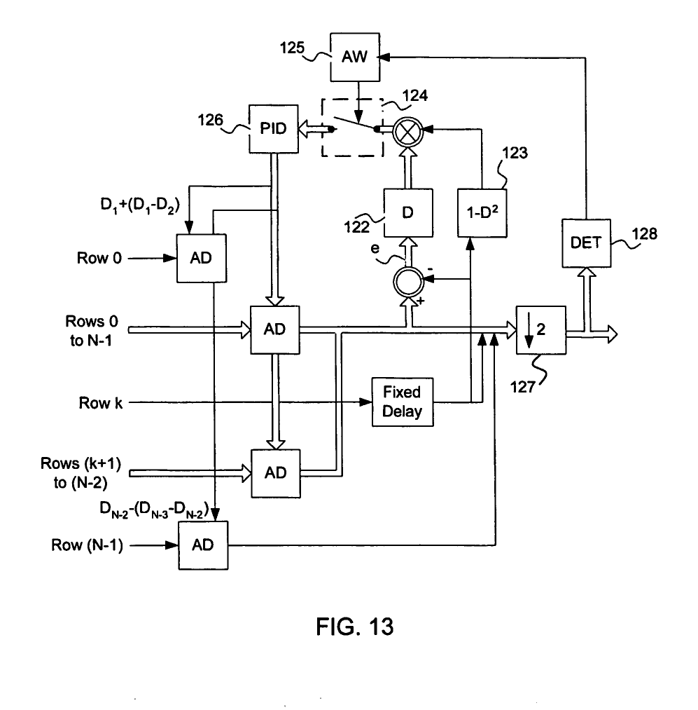

Still according to another embodiment, the method in accordance with the invention uses one of the inner rows (row “k”) between row “1” and “N−2” instead of row “0” (or “N−1”) as the reference signal with which all other rows (except the other outer row close to the guard band) have to be aligned through cross-correlation. This implies that the HF-signals of all the inner bit-rows “2”, “3” . . . “N−2” are aligned with respect to row “k”. For the outer bit-rows, another procedure has to be applied. For instance, we can take the same phase-delay between row “0” and “1” as has been obtained between row “1” and “2”. The total phase delay for row “0” then becomes (denoting the phase delay of row “i” by Dᵢ): D₀=D₁+(D₁−D₂). For the second outer row, we can take a phase delay between row “N−2” and “N−1” equal to the phase-delay as obtained between row “N−3” and “N−2”. The total phase delay for row “N−1” then becomes: D_{N-1}=D_{N-2}−(D_{N-3}−D_{N-2}). A schematic diagram of this embodiment is shown in FIG. 13. Note that for the practical implementation, it is also needed now to delay the reference row (row “k”) with a fixed delay to obtain all positive delay values for the “delay compensation block”. This fixed delay should be not smaller than a minimum value with is equal to the (expected) delay between the outer row “0” (or the outer row “N−1”) and row “k”. The “expected” delay can be derived from the geometry of the broad spiral and the separation of the laser spots (as produced by the diffraction grating).

Another embodiment is possible for a two dimensional system with somewhat lower density. Here it might not be needed to have a full-fledged two-dimensional bit-detector. It may be possible to use cross-talk cancellation XTC and after XTC simply apply independently, one-dimensional PRML detectors. In such a configuration the adaptive filters that are applied to the adjacent channels before subtracting them from the central channels contain relative phase information. The phase information can be extracted by determining the ‘center-of-mass’ of the filter taps.

Several embodiments of the present invention have been described above by way of examples only, and it will be apparent to a person skilled in the art that modifications and variations can be made to the described embodiments without departing from the scope of the invention as defined by the appended claims. Further, in the claims, any reference signs placed between parentheses shall not be construed as limiting the claim. The term “comprising” does not exclude the presence of elements or steps other than those listed in a claim. The terms “a” or “an” does not exclude a plurality. The invention can be implemented by means of hardware comprising several distinct elements, and by means of a suitably programmed computer. In a device claim enumerating several means, several of these means can be embodied by one and the same item of hardware. The mere fact that measures are recited in mutually different independent claims does not indicate that a combination of these measures cannot be used to advantage.

1. A method of synchronizing signals coming from a set of data channels of a two dimensional optical read-out system, said method comprising the steps of:
cross-correlating the signals of a pair of adjacent channels for determining a relative phase delay between said adjacent channels,
iterating the cross-correlation step for the different pair of adjacent channels of the set of data channels,
compensating for the relative phase delays thus obtained in order to align the signals from adjacent channels with each other.

2. A method as claimed in claim 1, wherein the cross-correlating step is based on cross-talk between signals that are measured in successive channels that correspond to adjacent rows of bits.

3. A method as claimed in claim 1, wherein said cross-correlating is based on a similarity between the signals that are measured in successive channels that correspond to adjacent rows of bits, said similarity being realized by a predetermined preamble structure that is uniform along one direction of a two dimensional lattice of bits corresponding to a set of adjacent row of bits, said direction being different from the tangential direction of said lattice.

4. A device for synchronizing signals coming from a set of data channels for use in a two dimensional optical read-out system, said synchronization device comprising:
cross-correlators adapted to determine the relative phase delays between pairs of adjacent channels,
a delay compensator for compensating for the relative phase delays thus obtained in order to align the signals from adjacent channels with each other.

5. A device as claimed in claim 4, the delay compensator comprising for a current pair of adjacent channels:
a delay circuit (62;70;81) for delaying a signal from a first channel of a pair of a predetermined delay, thus forming a delayed signal,
a first variable delay circuit (64;71;82) in series with a differentiator circuit (61;72;83) for determining a derivative signal from a second channel of a pair,
an integrating loop filter (63;73;84) able to receive a cross-correlation of the delayed signal and of the derivative signal, said filter being able to control the variable delay of the variable delay circuit.

6. A device as claimed in claim 5, wherein the delayed signal or the derivative signal forms an input of a cross-correlator corresponding to a next pair of adjacent channels.

7. A device as claimed in claim 5, wherein the outputs of the integrating loop filters (84,88) are added, the delay compensator comprising, for a current pair of adjacent channels, a second variable delay circuit (89) which is controlled by accumulated outputs of the integrating loop filters corresponding to all previous pairs of adjacent channels and by the output of the first variable delay circuit (86) of a second channel of a current pair, the output of the second variable delay circuit forming an output of the synchronization device.

8. A device as claimed in claim 4, comprising:
N registers for storing integrator values for N variable delays, where N is an integer,
a single cross-correlator circuit used for each pair of adjacent channels sequentially, an update value being added to a register value and stored again in the same register in order to implement an integration function.

9. A device as claimed in claim 4, comprising:
a set of N−1 variable delay circuits (91) for delaying signals from track 2 to N by a variable delay, where N is an integer,
a set of cross-correlators (92) for correlating each pair of delayed signals,
an integrating loop filter (93) for receiving a sum of the correlated signals, and for feeding the inputs of the set of N−1 variable delay circuits (91).

10. A device as claimed in claim 4, comprising:
a set of N analog-to-digital converters (101) for digitizing signals from channels 1 to N, where N is an integer,
means (102) for compensating the digitized signals for an integer delay,
a set of N−1 cross-correlators (103) for correlating the compensated signals from adjacent channels,
an integrating loop filter (104) for integrating a sum of the correlated signals,
a controlled oscillator (105) driven by the integrating loop filter, which oscillator generates the clock for the analog-to-digital converters.

11. A two dimensional optical recording and/or reproducing apparatus comprising a device as claimed in claim 4, able to deliver synchronized signals to a two-dimensional equalizer in series with a sample rate converter and a bit detector.
